(19) United States
(12) Patent Application Publication
(10) Pub. No.: US 2013/0262332 A1
(43) Pub. Date: Oct. 3, 2013

(54) Entity-Focused Social Media Method and System

(71) Applicants: Alaina Moon, Kalispell, MT (US); Tracy Moon, Kalispell, MT (US)

(72) Inventors: Alaina Moon, Kalispell, MT (US); Tracy Moon, Kalispell, MT (US)

(21) Appl. No.: 13/832,259

(22) Filed: Mar. 15, 2013

Related U.S. Application Data
(60) Provisional application No. 61/619,407, filed on Apr. 2, 2012.

(51) Int. Cl. H04L 29/08

(52) U.S. Cl. CPC H04L 67/22
USPC 705/319; 709/204

(57) ABSTRACT

A social media that enables the user to create a personal space affiliated with an interest, in which the user may share individual data. The user may interact with other users who share the interest, in a virtual interaction area. The user may be allowed to permit escorted or unescorted friends limited access to the user's personal space and the interaction spaces to which they belong. The user may also interact with other users who share a related interest, but prefer an alternate competitor entity in the field of interest. Alternate competitor interaction may provide users from each competitor entity limited special insight into the particular competitor entity, to enrich the interaction experience of users from both entities. The user may establish multiple personal spaces, and link their individual interests through one personal space to another, so as to share insight into those other interests with the other users.

### CROSS-REFERENCE TO RELATED APPLICATIONS

This application claims the benefit of provisional patent application No. 61/619,407, filed 2 Apr. 2012 by the present inventors, Alaina Moon and Tracy Moon.

### STATEMENT REGARDING FEDERALLY SPONSORED RESEARCH OR DEVELOPMENT

Not Applicable.

### BACKGROUND OF THE INVENTION

The subject matter of the present application relates to web-based social networking and more particularly relates to a method establishing a web-based social network oriented on shared support and appreciation of a particular interest.

The Internet has given rise to web-based social networking and electronic communication. A user of any of a variety social networking platforms may maintain connections with friends, and communicate with these friends, post electronic media such as photos, videos, and the like, and express thoughts and opinions for those friends and others to view and comment upon.

A variety of social media platforms provide opportunities for people to establish an online persona and forge connections to other individuals and groups. Web-based systems, such as Facebook®, MySpace®, and Google+®, permit a person to create an entity profile and then focus on connection to the individual or organizational profiles of other entities. These profiles provide a viewer of their profile a wide-range of information about the entity. Additionally, the entity, or viewer, may communicate and contribute thoughts that may be become additions to either or both entities' profile. Additionally, an alternative web-based system, such as Pinterest®, permit a person to create an entity profile to which the entity may post images of items of interest to the entity to demonstrate to others who may view the profile what the entity is experiencing, and typically perceiving as favorable. Current web-based systems principally orient on enabling people to create an individual virtual persona, and interact as that persona with other virtual persona, and secondarily express a connection to or interest in a particular interest, such as an individuals, activities, sports, cause, and organizations.

It would be desirable to have a web-based system focused primarily on facilitating an individual's connection to a particular interest, such as an individuals, activities, sports, cause, and organizations, and then secondarily to other individuals who either share the particular interest, or have a mutual friendship.

### SUMMARY OF THE INVENTION

The current social media system is virtual networks oriented on a central theme of competition and competitors, where the user's interaction is as a proponent of an entity in which the user has a strong interest. The system enables the user to create a personal space affiliateable with an interest, in which the user may post individual facts that they care to share. From the user's personal space the user may interact with other users who share the interest, in a virtual interaction area. The user may be allowed to permit either escorted or unescorted friends to have limited access to the user's personal space and the interaction space to which the user belongs. The user may also interact with other users who share a related interest, but prefer an alternate competitor entity in the field of interest. Alternate competitor interaction would provide users from each competitor entity limited special insight into the particular competitor entity, to enrich the interaction experience of users from both entities. Additionally, the user may establish other interests, for example multiple personal spaces, and link those individual interests through their personal space, so as to share insight into those other interests with the users they interact with.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a schematic diagram of an exemplary social media system of the present disclosure;

FIG. 2 is a schematic diagram of an exemplary interest office of the exemplary social media system of FIG. 1;

FIG. 3 is a schematic diagram of an exemplary personal page of the exemplary social media system of FIG. 1;

FIG. 4 is a schematic diagram of an exemplary subject-themed space of the exemplary social media system of FIG. 1;

FIG. 5 is an illustration of an exemplary sign-in and enrollment template for an exemplary social media system of the present disclosure;

FIG. 6 is an illustration of an exemplary personal page update template for an exemplary social media system of the present disclosure;

FIG. 7 is an illustration of an exemplary personal page for an exemplary social media system of the present disclosure;

FIG. 8 is an illustration of an exemplary team page for an exemplary social media system of the present disclosure; and

FIG. 9 is an illustration of an exemplary other interests page for an exemplary social media system of the present disclosure.

### DESCRIPTION OF THE PREFERRED EMBODIMENT

In an exemplary embodiment, the components of the social media system may have name designations relating to sports, such as a user may be called a “Fan,” the user's virtual personal space may be called a “Locker,” and a virtual subject-themed space may be called a “Stadium.” Similarly, in an exemplary embodiment, an interest may be called a “Team,” and an interest office may be called a “Team Office.” Similarly, in an exemplary embodiment, a friends who may be given limited access may be called an “Ally,” a user of a competitor entity may be called a “Rival,” and a personal space for other interests may be called “OT” or “Over Time.”

A “Fan” area is where the user comes into their “locker room.” The user's personal space begins with a free “locker” for their personal information. The user volunteers any personal information they choose in their “'stats,” or “statistics” page. They are able to choose any favorite team, player, organization that they want to be a fan each category (professional, college, high school, etc.). This automatically links to all the fans that have chosen the same favorite entity. In their locker they can upload a “roster” picture and have a limited number of free other pictures, and of course have the ability to share their thoughts. At this point the fan can keep a free locker or pay a monthly fee to decorate their locker with a background of team emblems, borders, pictures, team music, sounds, etc.

The “Ally” area is a virtual space for users who have no team connection to a specific user, but could be the Fan's family, friends, co-workers, and etc. The Fan would be able to acquire “Ally” passes for access to the site and related activities, so they can selectively share their virtual experience with family and friends.

The “Rival” area is a communication area in the platform that permits a Fan special insight and interaction with an opposing entity, such as an pending opposing team or business competitor. Such information for a sports team may be team roster, coach, and key player stats. For a business competitor it could be the structure and composition of the management team, the annual sales statistics, and recent relevant news articles in which the competitor was mentioned. The Rival area can be a forum for playful banter, posturing, and psychological gamesmanship, all for fun and entertainment purposes.

The “O.T.” area is an area for links to the user's other interests and activities, and may include a link to the other entities with which the user is connected. Such links can be to the user's other “lockers” or other entity “stadiums” where the user expresses their close connection to that other interest.

When a fan clicks on one of his favorite team logos, he enters that team's “stadium” page. Inside the stadium the user is allowed to “announce” (post) notes to the team and fellow fans, and collectively interact with them, to include things like post video, audio, and etc. The user is also able to post on the team's forum. The team can post updates, stadium directions, ticket information or sales links, general merchandise, advertising, video, audio, and etc. The team and the fan can also post classified advertisements of interest to the fan base.

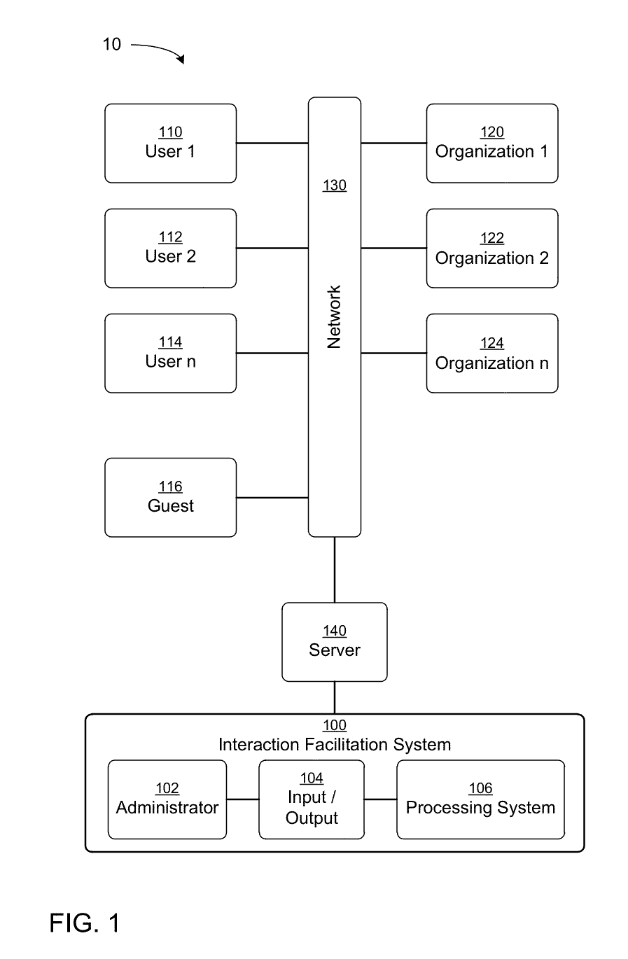

A social media method and system will now be described in detail with reference to the accompanying drawings. Referring now to FIG. 1, an exemplary social media system 10 employing an exemplary interaction facilitation system 100 is depicted. The social media system 10 permits a number of entities, including user 1 110, user 2 112, user n 114, guest 116, organization 1 120, organization 2 122, and organization n 124 to access and interact with the interaction facilitation system 100 through a network 130. Network 130 may be a suitable interconnected communication environment, such as the Internet. Users 1, 2, and n (110, 112, 114), guest 116, and organizations 1, 2, and n (120, 122, 124) may access the network by personal computing devices, and the exemplary interaction facilitation system 100 access the network 130 via server 140. The exemplary interaction facilitation system 100 is configured to permit users 1, 2, and n (110, 112, 114), guest 116, and organizations 1, 2, and n (120, 122, 124) to share data, and may be in the form of a controlled access page on the World Wide Web.

The exemplary interaction facilitation system 100 manages and manipulates the experience and interaction of the users 1, 2, and n (110, 112, 114), guest 116, and organizations 1, 2, and n (120, 122, 124). The interaction facilitation system shown in FIG. 1 has an administrator 102, an input/output module 104, and a processing system module 106. The administrator 102 controls the operation and function of the input/output module 104, and the processing system module 106. The input/output module 104 provides an interface with the network 130, to send communication, such as electronic instructions, to the network 130, and receive data transmissions from the network 130 that contain the data regarding responses and activity of the users 1, 2, and n (110, 112, 114), guest 116, and organizations 1, 2, and n (120, 122, 124). The particular data from users 1, 2, and n (110, 112, 114), guest 116, and organizations 1, 2, and n (120, 122, 124), are received as distinct communication through input/output module 104, and passes to the processing system module 106. The administrator 102 provides the instructions that coordinate what communication the input/output module 104 has with the network 130, and directs the verification and transfer of the incoming data into the processing system 106 based on the authorization and access the particular users 1, 2, and n (110, 112, 114), guest 116, and organizations 1, 2, and n (120, 122, 124) is supposed to have within the interaction facilitation system 100.

In an exemplary sports-centered embodiment, users 1, 2, and n (110, 112, 114) are referred to individually as a fan, and collectively as fans. With respect to user n 114, user 1 110 is a fan of a team that is liked by the perspective of user n's 114 interest in his team. With respect to user n 114, user 2 112 is a fan of a team that is disliked by the perspective of user n's 114 interest in his team.

In an exemplary sports-centered embodiment, organizations n 124 is a sports team user n 114, fan n 114, is interested in, organization 1 120 is a team the fan n 114 likes in the perspective of the fan n's 114 interest in the fan n's team, organization n 124, and organization 2 122 is a sports team the fan n 114 dislikes in the perspective of the fan n's 114 interest in the fan's team, organization n 124. In an exemplary sports-centered embodiment, a guest may be one type of an ally, as may be organization 1 120, and fan 1 110, a fan of organization 1 120. In an exemplary sports-centered embodiment, organization 2 122, and fan 2 112, a fan of organization 2 122, may be referred to as a rival.

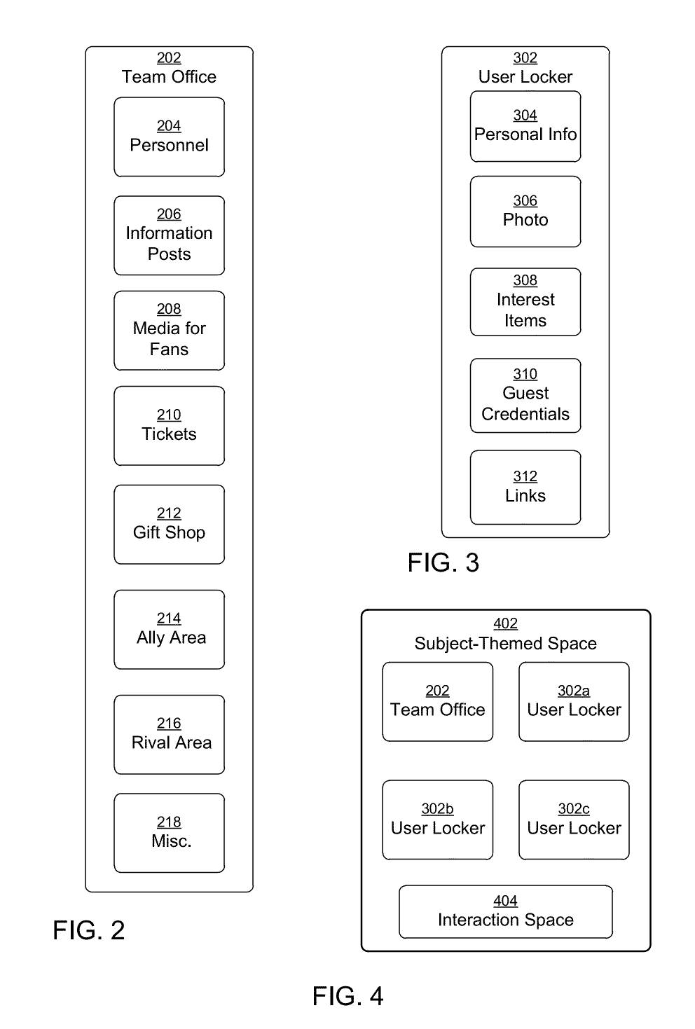

Referring now to FIG. 2, a suitable exemplary entity space 202 may be referred to as a team office 202. Team office 202 may have a variety of information and data components that may be identified individually. In the exemplary team office 202 there is a data component for team personnel information 204, informational posts 206, media for fans 208, ticket information and purchases 210, gift shop items 212, an ally area 214, a rival area 216, and a miscellaneous area 218. The personnel area 204 is where the team n 124 may post information about the team and the team's people that fan n 114 would be interested in and might enrich the fan's experience of supporting the team. This information may include stats on players and the lineup, potential trades, coach and manager information and exchanges, employment opportunities, and other potentially important or entertaining information about the team's people.

The information posts area 206 may be a place for the team to provide other information about upcoming events that fans would be interested in and might enrich the fan's experience of supporting the team. The media for fans 208 may be various forms of media packaged for fan viewing or use, such as photos, sound bites, ring tones, video clips, logos, and screen shots.

The ally area 214 and the rival area 216 are sections of the team office 202 where the fan n 114 can interact with fan 1 110 and fan 2 112. The team n 124 may use the miscellaneous area 218 for a variety of controlled interaction with fan n 114.

Referring now to FIG. 3, an exemplary personal space 302 may be referred to as a locker 302. Locker 302 may have a variety of information and data components that may be identified individually. In the exemplary locker 302 there is a data component for the fan's personnel information 204, photos 306, items identifying the fan's interests 308, credentials for guests the fan is or has sponsored 310, and links to the fan's other interests 312, which in the exemplary embodiment may be referred to as the fan's overtime area 312.

Referring now to FIG. 4, an exemplary subject-themed space 402, continuing the exemplary sports theme, may be referred to as the particular place where a particular subject activity, or the exemplary sporting event, may typically be found. Given an exemplary subject of football, the corresponding particular subject place might be a stadium, so the exemplary subject-themed space may be referred to as a stadium 402. The exemplary stadium 402 may have a variety of information and data areas, and an interaction space 404, which may be referred to in the corresponding exemplary embodiment as field 404. An exemplary stadium 402 may host interaction for team n 124, and fan n's 114 locker 302a. Exemplary stadium 402 may host team office 202 that fans n 114 may view. Other fans of team n 124 will have individual lockers (302b, 302c) that fan n 114 may view. Additionally, fan n 114 may exchange communication and media with other fans of team n 124 on the field 404.

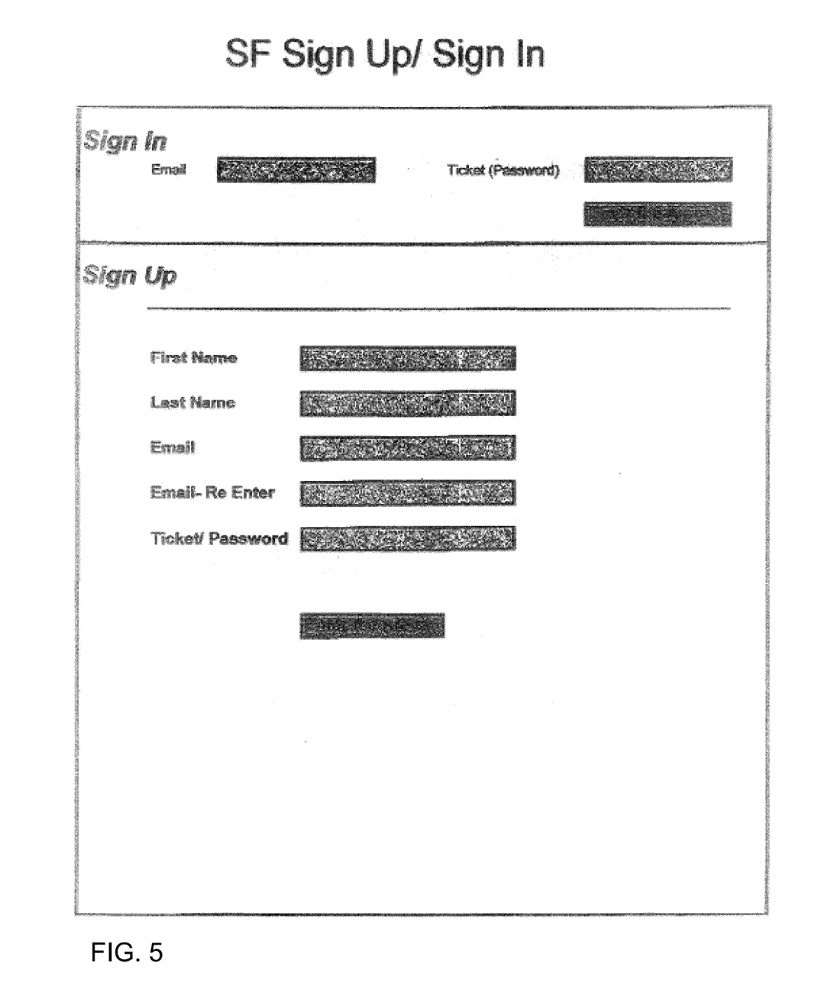

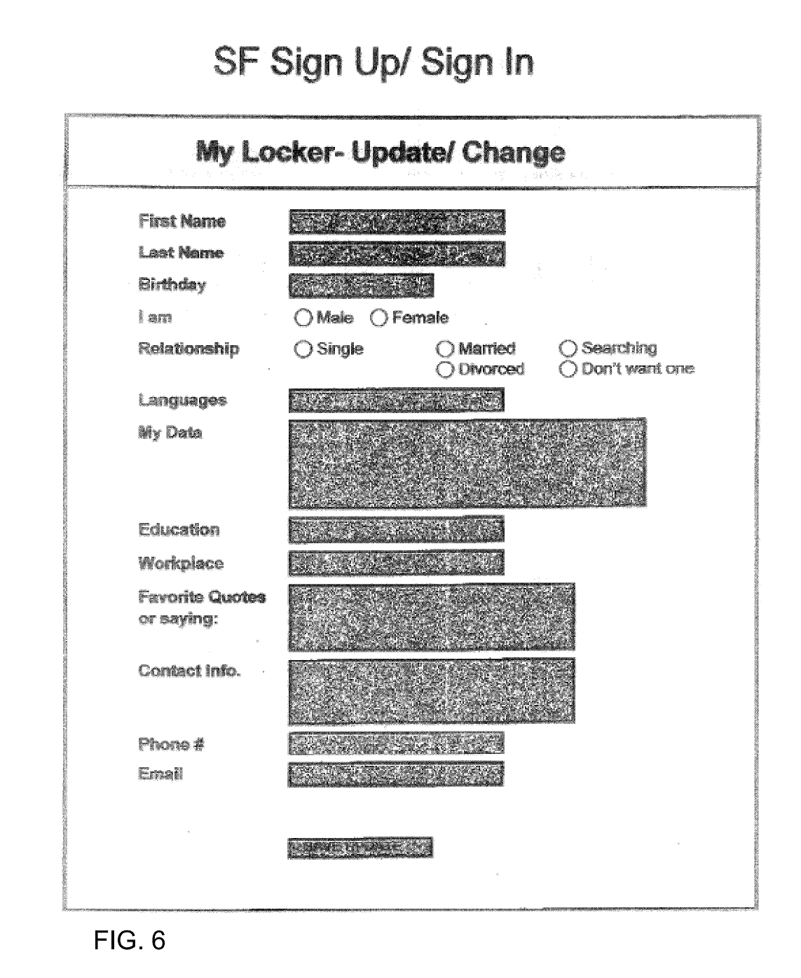

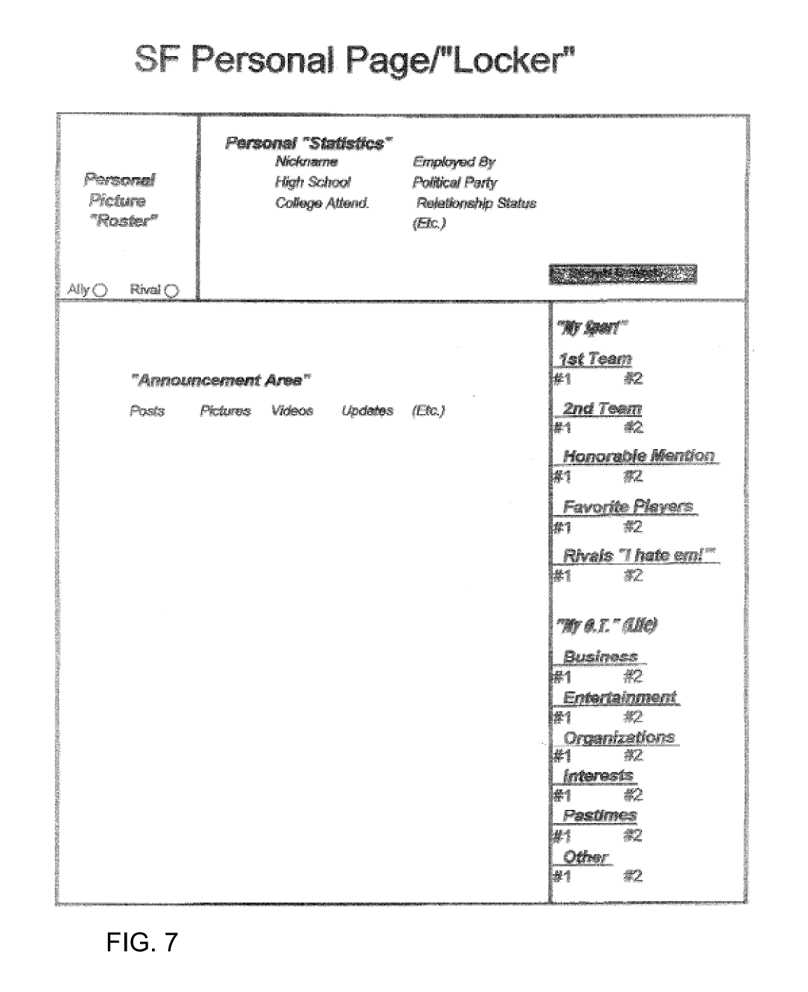

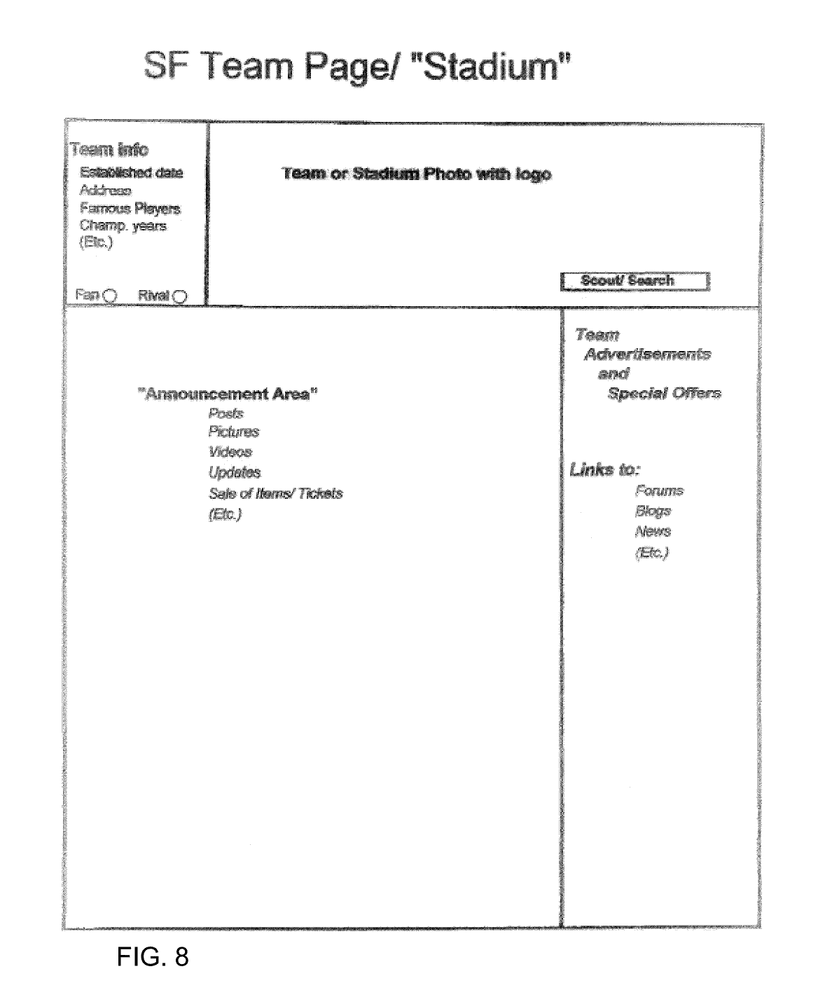

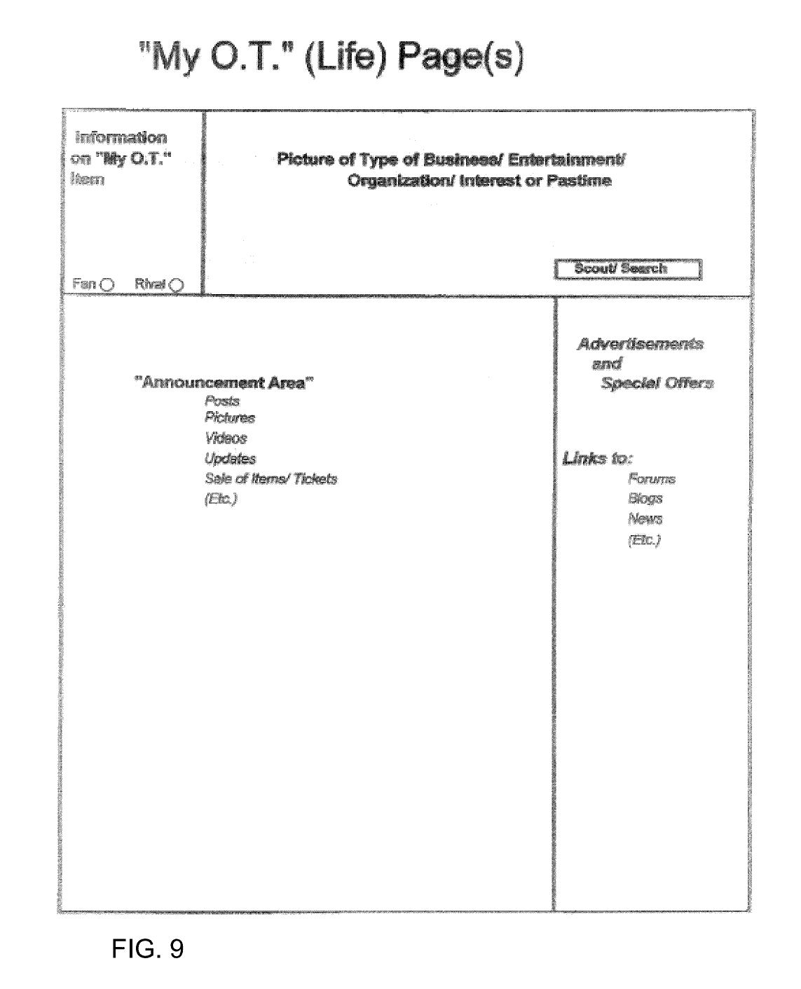

Referring now to FIG. 5, an exemplary sign in and sign up page is offered. Referring now to FIG. 6, an exemplary update and change page is offered. Referring now to FIG. 7, an exemplary personal page 302 or locker 302 is offered. Referring now to FIG. 8, an exemplary subject-themed page 402 or stadium 402 is offered. Referring now to FIG. 9, an exemplary O.T. page 312, or links 312 to other aspects of the fan n's 114 life that the fan desires to share.

In alternate exemplary embodiments, the subject-themed space 402 or Stadium 402 may be named other subjects, which may include activities venues, such as Raceway, Arena, Pitch, Field, Diamond, Park, Bowl, Rink, Ring, Floor, Hall, Court, Stage, Concert Hall, Mat, Gym, Pool, Alley, Course, Boardroom, Exchange, and other areas where competitors compete. Similarly, in alternate exemplary embodiments, the Locker may be referred to other personal places, such as the Pit, Green Room, Paddock or Stable, Slip or Marina, Trailer, Office, Clubhouse, and other areas where competitors prepare. The lexicon of other subjects may be competitive groupings, for example, sports, leagues, divisions, conferences, classes, industries, recording studios, market exchanges, markets, etc., may be used to create a virtual competitive activity environment still within the scope of the envisioned and disclosed system and method. A non-exhaustive list of subjects that are interests may fall in the fields of sports, entertainment fields, business, affiliations and organizations, pastimes, hobbies and interests, and may include:

Sports—Professional/National/Collegiate/High school/Club:

| | |
|---|---|
| 1. | Football leagues (NFL (AFC & |
| | NFC), CFL, Arena, AFL, NCAA) |
| 2. | Football teams |
| 3. | Basketball leagues (NBA, WNBA) |
| 4. | Basketball teams |
| 5. | Hockey leagues |
| 6. | Hockey teams |
| 7. | Baseball leagues |
| 8. | Baseball teams |
| 9. | Golf (PGA, LPGA) |
| 10. | Wrestling (WWE, TNA, ECW) |
| 11. | Racing (auto, motorcycle, |
| | snowmobile, truck, sail & power |
| | boats, BMX, horse, dog, airplane) |
| 12. | Racing Teams |
| 13. | Soccer leagues |
| 14. | Soccer teams |
| 15. | Tennis |
| 16. | Boxing |
| 17. | Ultimate fighting |
| 18. | Martial arts |
| 19. | Rugby |
| 20. | Volleyball (indoor, beach) |
| 21. | Surfing |
| 22. | Cheerleading |
| 23. | Cheerleading squads |
| 24. | Gymnastics |
| 25. | Lacrosse |
| 26. | Cricket |
| 27. | Polo (traditional, water, team) |
| 28. | Bands |
| 29. | Drill teams |
| 30. | Olympics (Winter & Summer) |
| 31. | X-Games |
| 32. | Triathlon |
| 33. | Running |
| 34. | Fishing |
| 35. | Skiing (snow, water) |
| 36. | Snowboarding |
| 37. | Skateboarding |
| 38. | Billiards |
| 39. | Bowling |
| 40. | Wheelchair and Ambulatory sports |
| 41. | Poker & Gambling |
| 42. | Body building |
| 43. | Shows & Exhibitions |
| 44. | Animals |
| 45. | Drivers & Jockeys |
| 46. | Individual athletes |
| 47. | Individual coaches & trainers |
| 48. | Team owners & managers |
| 49. | Team mascots |
| 50. | Sports writers |
| 51. | Sports networks & media outlets |
| 52. | Sports shows |
| 53. | Media personalities |
| 54. | Fantasy leagues |

Events/Bowls/Play-offs/Tournaments:

| | |
|---|---|
| 1. | Super Bowl |
| 2. | World Series |
| 3. | World Cup |
| 4. | College Bowl Games |
| 5. | FCS Tournaments |
| 6. | Olympics (Winter & Summer) |
| 7. | Goowill Games |
| 8. | NCAA Tournaments |
| 9. | Triple Crown |
| 10. | Golf's Grand Slam Events |
| 11. | Tennis' Grand Slam Events |
| 12. | The Masters |
| 13. | The Shell Houston Open |
| 14. | Rodeo Nationals |
| 15. | Houston Livestock Show & Rodeo |
| 16. | Individual Competitors & Teams |

Entertainment:

| | |
|---|---|
| 1. | Music |
| 2. | Movies |
| 3. | Theater |
| 4. | Books |
| 5. | Television |
| 6. | Radio |
| 7. | Singer |
| 8. | Author |
| 9. | Actor |
| 10. | Musician |
| 11. | Dancer |
| 12. | Announcer |

Business:

1. Industries
2. Markets
3. Exchanges
4. Institutions
5. Professions
6. Geographic distinctions

Affiliations and Organizations:

| | |
|---|---|
| 1. | Religion |
| 2. | Politics |
| 3. | Race |
| 4. | Gender |
| 5. | Nationality |
| 6. | Country |
| 7. | State |
| 8. | City |
| 9. | Language |
| 10. | Foundations |
| 11. | Civic organizations |
| 12. | Clubs |

Pastimes, Hobbies, and Interests:

| | |
|---|---|
| 1. | Art |
| 2. | Crafts |
| 3. | Camping |
| 4. | Fishing |
| 5. | Climbing |
| 6. | Sky Diving |
| 7. | Diving |
| 8. | Para-sports |
| 9. | Philately |
| 10. | Collecting |
| 11. | Jewelry making |
| 12. | Couponing |

The format is conducive to a variety of monetization avenues, which may include:

| | |
|---|---|
| 1. | Tiered subscriptions of users and |
| | organizations |
| 2. | Advertising sales |
| 3. | User posted classified ads |
| 4. | Organizational ads |
| 5. | Media distribution royalties |
| 6. | Ticket distribution royalties |
| 7. | Licensed merchandise distribution |
| | royalties |
| 8. | Sporting equipment sales |
| 9. | Tournament Organization fees |
| 10. | Program & event streaming |
| 11. | Subscription options to permit |
| | enhanced personal information |
| | control |

The foregoing disclosure and description is illustrative and explanatory thereof. Any present invention should only be limited by the allowed claims and their legal equivalents. The allowed claims should be given their broadest interpretation, given the reasonable meanings of the words used herein, combined with the reasonable interpretation of one having ordinary skill in the art of web-based social networking. The inventor trusts and relies on these legal principle, in order to avoid being unnecessarily repetitive and verbose. Various changes in the details of the illustrated construction may be made within the scope of the appended claims by one having ordinary skill in the art without departing from the spirit of the invention and scope of the claims.

I claim:

1. An interaction facilitation system, stored and operated on a computer server linked to a network accessible to a large community of interconnected personal computers each computer operated by a user, said interaction facilitation system comprising:
at least one subject and a subject-themed virtual space with an interaction space;
the subject-themed space being controllably accessible by multiple individual and entity avatars;
each said individual avatar customizable by an individual user via a personal computer to represent chosen characterization of a relationship to the subject by the individual, and each said entity avatar customizable by a representative user of an entity via a personal computer to depict chosen characterization of a relationship with the subject by the entity;
individual avatars and entity avatars elect a group of representative information from their chosen characterization of their relationship with the subject to selectively share with other users;
individual avatars and entity avatars elect permissible interaction activities with other individual avatars and entity avatars; and
particular interaction activity occur in an interaction space in the subject space.

2. The interaction facilitation system of claim 1, wherein:
the individual's chosen characterization of a relationship includes at least one of the following: personal information, photo, interests, guests, and links to web sites of other or additional interests.

3. The interaction facilitation system of claim 1, wherein:
the entity's chosen characterization of a relationship with the subject includes at least one of the following: entity personnel information, updatable information, accessible media, downloadable media, ticket information, ticket sales, gift information, gift sales, related entity information, affiliated entity information, and rival entity information.

4. The interaction facilitation system of claim 1, wherein:
the individual's chosen characterization of a relationship is selectable from a set of choices that include one who has a favorable connection to the subject, one whose connection to the subject is more favorable than unfavorable, and one who has an unfavorable connection to the subject.

5. The interaction facilitation system of claim 1, wherein:
the subject is an activity that can be categorized as at least one of a sport, an event, an entertainer, an entertainment venue, a celebrity, a group, an art form, a location, a locality, a culture, a business, an organization, and an interests.

6. The interaction facilitation system of claim 1, wherein:
the permissible interaction activities chosen by at least two users is an exchange of either or both opinions and thoughts.

7. The interaction facilitation system of claim 1, wherein:
the permissible interaction activities chosen by at least two users is a commercial exchange.

8. The interaction facilitation system of claim 1, wherein:
the permissible interaction activities chosen by at least two users is the purchase and sale of goods.

9. The interaction facilitation system of claim 1, wherein:
the permissible interaction activities chosen by at least two users is the purchase and sale of tickets.

10. The interaction facilitation system of claim 1, wherein:
the permissible interaction activities chosen by at least two users is the transfer of promotional items.

11. The interaction facilitation system of claim 1, wherein:
the permissible interaction activities chosen by at least two users is the facilitation of a sweepstake.

12. The interaction facilitation system of claim 1, further comprising:
The subject-themed space permits a user to create a customized layout.

13. The interaction facilitation system of claim 1, further comprising:
the subject-themed space permits display of a depiction of the subject, at least one individual avatar, at least one entity avatar, and an interaction area for input and output.

14. The interaction facilitation system of claim 13 (−1), wherein:
the subject-themed space permits display of user controllable links.

15. The interaction facilitation system of claim 1, further comprising:
a subject search function that assists users in finding and connecting to available subjects.

16. The interaction facilitation system of claim 1, further comprising:
a subject creation function that assists users in establishing a new subject-themed space on a subject of the user's choice.

17. The interaction facilitation system of claim 1, further comprising:
the creation of revenue from customizable user subscription access to the subject-themed space, customizable user subscription access to the subject-themed space, advertising space in the subject-themed space, user posted classified ads in the subject-themed space, distribution royalties for media accessed in the subject-themed space, distribution royalties for good accessed in the subject-themed space, commissions from sales initiated in the subject-themed space, or custom subject-themed space hosting fees.

18. An commercial transaction system, stored and operated on a computer server linked to a network accessible to a large community of interconnected personal computers each computer operated by a user, said interaction facilitation system comprising:
at least one subject and a subject-themed virtual space with an interaction space;
the subject-themed space being controllably accessible by multiple individual and entity avatars;
each said individual avatar customizable by an individual user via a personal computer to represent chosen characterization of a relationship to the subject by the individual, and each said entity avatar customizable by a representative user of an entity via a personal computer to depict chosen characterization of a relationship with the subject by the entity;
at least one individual avatar communicates types of commercial exchange relationships they would like to enter and with what entities they would like to enter such a relationship; and
at least one entity avatar communicate types of commercial exchange relationships they would like to enter and with what individuals they would like to enter such a relationship.

19. The transaction system of claim 18, wherein:
a commercial exchange relationship communicated by both an individual avatar and an entity avatar is the purchase and sale of goods, the purchase and sale of tickets, the transfer of promotional items, or the facilitation of a sweepstake.

20. The transaction system of claim 18, further comprising:
the creation of revenue from customizable user subscription access to the subject-themed space, customizable user subscription access to the subject-themed space, advertising space in the subject-themed space, user posted classified ads in the subject-themed space, distribution royalties for media accessed in the subject-themed space, distribution royalties for good accessed in the subject-themed space, commissions from sales initiated in the subject-themed space, or custom subject-themed space hosting fees.
